(19) United States
(12) Patent Application Publication
(10) Pub. No.: US 2023/0367265 A1
(43) Pub. Date: Nov. 16, 2023

(54) HOROLOGICAL MECHANISM FOR ACTUATING A FLEXIBLE HAND

(71) Applicant: Montres Breguet S.A., L'Abbaye (CH)

(72) Inventors: Marc STRANCZL, Nyon (CH); Lionel MATTHEY-DE-L'ENDROIT, St-Livres (CH); Peter HYDE, Le Sentier (CH); René PIGUET, Cheseaux-sur-Lausanne (CH)

(73) Assignee: Montres Breguet S.A., L'Abbaye (CH)

(21) Appl. No.: 18/174,146

(22) Filed: Feb. 24, 2023

(30) Foreign Application Priority Data
May 11, 2022 (EP) 22172718.3

(51) Int. Cl. G04B 19/04; G04B 19/02; G04B 13/02

(52) U.S. Cl. CPC G04B 19/048; G04B 19/02; G04B 13/027

(57) ABSTRACT

A flexible hand actuation mechanism to which a disk of a horological movement applies a first angular rotation (θ1), the flexible hand including a first cannon and a second cannon connected to a point of the flexible hand via flexible arms, an operating position where the first cannon and the second cannon are coaxial about an exit axis, the first cannon being fitted with a first defined prestress angle, the second cannon being fitted with a second defined prestress angle of opposite direction to that of the first cannon, the actuation mechanism being arranged to actuate the flexible hand such that the latter changes shape and length in the desired manner by varying the angular position of the second cannon with respect to the first cannon by pivoting about the exit axis.

### TECHNICAL FIELD OF THE INVENTION

The present invention relates to a horological mechanism for actuating a flexible hand.

### TECHNOLOGICAL BACKGROUND

The hand is the most common display mode for representing particularly time in an analogue manner. The Applicant is reinterpreting this display mode by proposing a flexible hand, the shape and length thereof are modified so that, for example, the point of the hand follows the ovoid periphery of a watch dial as closely as possible. The display thus embodied is gauged intuitively thanks to the variations of shape of the hand over time. Such a flexible hand is particularly the subject of European patent applications EP 3159751A1 and EP 3605243A1 held by the Applicant.

For two decades, flexible structures have represented a valuable research topic in the field of watchmaking. These flexible structures are composed of rigid elements connected to each other by flexible elements which are elastically deformed so as to fulfil guiding functions. As the operating principle thereof is based on the elastic deformation of the structure by preventing any plastic deformation of the material, these structures can be manufactured in one piece with a high degree of precision specific to horological manufacturing processes.

Compared with conventional guiding mechanisms, flexible structures enable a very precise movement, with no friction and therefore no need for lubrication. The rigidity of the structure implies a relationship between the force applied and the movement of this structure. The movement, subjected to a return force, contains no play or hysteresis.

The Applicant studied and applied the flexible structure principle to the minutes display on the “Coeur” model of the Reine de Naples collection. This iconic model is one of Maison Breguet's most emblematic models. Created in homage to the world's first watch designed to be worn on the wrist, it is characterised by the ovoid shape of its middle and has an hour circle off-centred towards the bottom part of the dial.

While the path of the point of a conventional hand is purely circular, the use of a flexible structure enables the minute hand of the Reine de Naples “Coeur” watch to have a variable length and shape. The point of the minute hand is then capable of following the ovoid perimeter of the dial. The minute hand therefore itself acts as a flexible guidance. In the case of the hour display, it is performed in an aperture at the centre of the dial.

FIGS. 1A and 1B illustrate two display statuses of the watch. In FIG. 1A, the watch indicates 9:00. In this scenario, the flexible minute hand 1 has a slender shape and the length L thereof is 16.8 mm; the point 2 of the flexible hand 1 points to the index “60” of the hour circle. In FIG. 1B, the watch indicates 9:23; the flexible hand 1 is elastically deformed and forms a heart wherein the point 2 points to the index “23” of the hour circle. The length L of the hand is then only 7.7 mm.

The geometry of the flexible hand 1 during the manufacture thereof is illustrated in FIG. 2A. In the shape of a heart, the flexible hand 1 is composed of a point 2 connected to two arms 4 and 6 each including a flexible part 4A, 6A, a rigid part 4B, 6B and a cannon 4C, 6C. It is made according to a LIGA process, preferably from a nickel-phosphorus alloy type material, the properties of which are particularly well-suited to the specificities sought. Indeed, the Young's modulus of this material is low enough to ensure flexibility, and the yield strength thereof is high, which minimises the risk of plastic deformation. The resistance of this material to fatigue cycles also ensures the stability of the mechanical and physical properties thereof over time. Another advantage is that this material is insensitive to magnetic fields.

The principle of deformation of the flexible hand 1 is illustrated in FIG. 2B. Once fitted on the movement, the two cannons 4C, 6C of the flexible hand 1 are superposed and actuated via two coaxial cannon-pinions (not shown). In the schematic example illustrated in FIG. 2B, the flexible hand 1 changes shape and length but does not turn; it switches from a first rest position wherein the length L thereof is 16.8 mm to a second elastically deformed position wherein the length L thereof is 7.7 mm. To switch the flexible hand 1 from the first to the second position thereof, an identical rotation by an angle φ but of opposite direction is applied on each of the arms 4, 6 of the flexible hand 1. It is therefore possible, for example by finite element simulation, to precisely determine the angle φ to be applied to the cannons 4C, 6C of the flexible hand 1 to obtain the sought length variation ΔL.

The actuation principle of the flexible hand 1 is illustrated in FIGS. 3A to 3C appended to the present patent application. It is understood that the complexity of the actuation mechanism of the flexible hand 1 lies in the determination of the rotation to be applied to the two cannons 4C, 6C thereof to obtain the sought length variation ΔL. Indeed, in order to modify the shape and the length of the flexible hand 1, each of the two arms 4, 6 thereof must be actuated separately.

For this purpose, and as illustrated in FIG. 3A which is a schematic diagram of the actuation of the flexible hand 1, the actuation mechanism is driven for example by the cannon-pinion of the horological movement which applies a rotation by an angle θ1 to the entry of an additional plate 7 which comprises the whole actuation mechanism. The actuation mechanism must convert the entry angle θ1 into a rotation by an angle α(θ1) of the right cannon 4C of the flexible hand 1, and into a rotation by an angle β(θ1) of the left cannon 6C.

FIG. 3B appended to the present patent application represents the angles of rotation of the cannons 4C and 6C of the flexible hand 1 so that the point 2 of this flexible hand 1 travels along an angle θ1 which corresponds to the rotation applied by the horological movement to the entry of the actuation mechanism. It is seen in this FIG. 3B that, for the point 2 of the flexible hand 1 to pivot by an angle θ1 and this flexible hand 1 to change from a substantially almond shape to a heart shape, the right cannon 4C must rotate by an angle α(θ1), and the left cannon 6C rotate by an angle β(θ1).

FIG. 3C appended to the present patent application illustrates the evolution of the angles of rotation a and 13 of the cannons 4C and 6C of the flexible hand 1 as a function of the angle of rotation θ1 which corresponds to the rotation applied by the horological movement to the entry of the actuation mechanism.

So that the flexible hand 1 changes shape and length while indicating the minute by means of the point 2 thereof, each cannon 4C, 6C must rotate by the angle θ1 corresponding to the angle which would be applied by the cannon-pinion of the horological movement to a conventional minute hand, this angle θ1 being modulated by an angle φ by the actuation mechanism so that the flexible hand 1 changes shape and length in the desired manner. This angle φ(θ1), applied with an opposite direction to the two cannons 4C and 6C, determines the shape and length variation ΔL(φ) of the flexible hand 1.

The exit angles α(θ1) and β(θ1) of the actuation mechanism thus observe the following relations:

α(θ1)=θ1+φ(θ1) (1)

β(θ1)=θ1−φ(θ1) (2)

The flexible hand 1 shown here being symmetrical, the angular position θ2 of the point 2 of the flexible hand 1 is defined as being the bisector of the two arms 4 and 6, i.e. the mean of the angles α(θ1) and 13(θ1) according to the relation:

$$θ 2 = \frac{α ( θ 1 ) + β ( θ 1 )}{2} = θ 1 \qquad ( 3 )$$

The angular position θ2 of the point 2 of the flexible hand 1 is therefore identical to θ1.

All the complexity lies in determining the value of the modulation angle φ(θ1). This value is dependent on the deformation properties of the flexible hand 1 which determine the modulation angle φ(θ1) to be applied to obtain the sought shape and length variation ΔL. A graphic representation of the evolution of the angles α, β and θ2 as a function of θ1 is illustrated in FIG. 3C.

Several actuation mechanisms of the flexible hand 1 can be envisaged. A first example of such an actuation mechanism is illustrated in FIGS. 4A to 4C appended to the present patent application. Designated as a whole by the general reference number 8, this actuation mechanism comprises a first and a second shape geartrains 10, respectively 12. As described in more detail hereinafter, these first and second shape geartrains 10, 12 comprise trains with non-circular toothing and are intended to add, for the right cannon 4C, and subtract, for the left cannon 6C, the modulation φ(θ1) at the entry angle θ1 in order to obtain the angles α(θ1) and β(θ1).

FIG. 4A appended to the present patent application is an exploded perspective view of a first embodiment of the actuation mechanism 8 of the flexible hand 1, where a movement gear 14, at a horological movement in the bottom part of the figure, is arranged to drive the two shape geartrains 10, 12, the first shape geartrain 10 being provided to drive the first right cannon 4C, and the second shape geartrain 12 being provided to drive the second left cannon 6C, first and second arrows illustrating the transmission of the movement to the first cannon 4C, respectively to the second cannon 6C. As seen in FIG. 4A, the first and second shape geartrains 10, 12 comprise shape geartrains which are arranged to introduce a phase shift into the rotation of one of the cannons with respect to the other cannon.

More specifically, to drive the first right cannon 4C, the first shape geartrain 10 comprises wheels fitted about a first axis DA, and wheels fitted coaxially about a main pivoting axis D. As regards the second shape geartrain 12, to drive the second left cannon 6C, it comprises wheels fitted about a second axis DB, and a wheel fitted on the main pivoting axis D. It will be noted that, in the fitted state thereof, the flexible hand 1 is prestressed, such that the entire actuation mechanism 8 is tensioned, which makes it possible to make up for any play in the train.

FIG. 4B appended to the present patent application is a partial sectional view of a horological movement driving an actuation mechanism of the type described above, and FIG. 4C appended to the present patent application is a perspective view in the assembled state of the actuation mechanism according to the first alternative embodiment illustrated in FIG. 4A. In these FIGS. 4B and 4C, an entry wheel of the actuation mechanism, arranged to cooperate with an exit wheel of the horological movement, is coaxial with a drive shaft and with a cannon-pinion whereon the first cannon of the flexible hand is shown fitted, the second cannon being shown in the free state of the flexible hand prior to the coaxial positioning thereof with the first cannon on the drive shaft. Each shape wheel includes an angular guide-marking so as to ensure the proper shape train effect.

More specifically, FIG. 4B illustrates the actuation mechanism 8 for the minute display with the flexible hand 1 and FIG. 4C illustrates a horological movement driving such an actuation mechanism 8. In this embodiment, an entry wheel 32 is guided on a fixed tube 34 centred on the main pivoting axis D. This entry wheel 32 is arranged to cooperate with the movement gear 14 formed by an exit disk of the horological movement. This entry wheel 32, for example a cannon-pinion, drives, directly or via friction indenting allowing hand-setting, a driving cannon-pinion 38 which is coaxial therewith.

This driving cannon-pinion 38 is revolving and drives a first shape wheel 40 which in turn meshes with a complementary second shape wheel 42 fitted about the first axis DA. This second shape wheel 42, pivotally secured to the first shape wheel 44, meshes with a complementary fourth shape wheel 46 fitted about the main pivoting axis D and which includes a cannon-pinion 48 for fastening the first cannon 4C.

The same driving cannon-pinion 38 drives a fifth shape wheel 50 which in turn meshes with a complementary sixth shape wheel 52 fitted about the second axis DB. This sixth shape wheel 52, pivotally secured to a seventh shape wheel 54, meshes with a complementary eighth shape wheel 56 which pivots about the main pivoting axis D and which includes a cannon-pinion 58 to which the second cannon 6C is fastened.

Each shape wheel can include an angular guide-marking so as to ensure the proper indexing thereof as illustrated in FIG. 5 which details a shape wheel with the seventh and eighth shape wheels 54, 56. These shape wheel 54, 56 are not revolving and each include a guide-mark 60, 62 for the indexing thereof in relation to one another, as well as oblong holes 64, 66 facilitating the positioning thereof.

The actuation mechanism 8 described above meets its specifications and has numerous advantages, particularly a simple, robust operation and an accurate display. Nevertheless, shape train actuation also has some limitations. The design is not easy to modify as a change of path of the point 2 of the flexible hand 1 implies a modification of the two shape geartrains 10 and 12. Moreover, the modulation of the angular movements φ of the arms 4, 6 of the flexible hand 1 is limited to moderate values as greater values would require shape trains deviating too much from the circular shape.

In the example described above with reference to FIG. 2B, the ratio between the length of the flexible hand 1 in the rest position thereof and the length of this flexible hand 1 in the elastically deformed position thereof is close to 2.2, which is beyond the technical possibilities in respect of modulation φ(θ1) of the actuation mechanism 8 with shape trains 10, 12. Consequently, so that the point 2 of the flexible hand 1 can accurately follow the ovoid periphery of the dial of the Reine de Naples “Coeur” watch, a novel actuation mechanism was developed.

Designated as a whole by the general reference number 68, this second embodiment of the actuation mechanism is illustrated in FIGS. 6A and 6B appended to the present patent application. This actuation mechanism 68 is arranged to drive a flexible hand 70 which, as shown in FIG. 6C, is composed of a point 72 connected to two arms 74 and 76 which are each fastened to a cannon-pinion 78, 80. The operating position of this flexible hand 70 is a stressed position wherein the two arms 74, 76 of the flexible hand 70 are fastened to the first cannon-pinion 78, respectively the second cannon-pinion 80, so as to be coaxial in relation to each other about an exit axis D′.

The actuation mechanism 68 includes first drive means θ2 of the first cannon-pinion 78 and second drive means 84 of the second cannon-pinion 80 about the exit axis D′.

The first drive means θ2 and the second drive means 84 are arranged to deform the flexible hand 70 by varying the angular position of the second cannon-pinion 80 with respect to the first cannon-pinion 78 by pivoting about the exit axis D′, which has the effect of varying the radial position of the point 72 with respect to this exit axis D′.

The actuation mechanism 68 includes a first differential 90 of which a first entry consists of a first cam 92, and a second differential 86 of which a first entry consists of a second cam 88. According to the configuration adopted, these first and second cams 88, 92 can be fixed or mobile.

The actuation mechanism 68 is completed by a planetary wheel-holding frame 94 which forms the second entry of the first and second differentials 86, 90. This planetary wheel-holding frame 94 bears first and second planetary wheels 96, 98 which are each equipped with a cam follower finger 100, 102 arranged to follow the profile 104, 106 of the corresponding cam 88, 92.

Finally, the first differential 90 has the first cannon-pinion 78 as an exit, and the second differential 86 has the second cannon-pinion 80 as an exit.

As seen in FIG. 6B, the second planetary wheel 98 is fitted free to rotate on a top pivot 108 of the planetary wheel-holding frame 94 which is in turn fitted free to rotate about the exit axis D′.

A solar pinion is formed by a second toothing 110 borne by the second cannon-pinion 80.

The first planetary wheel 96 is fitted free to rotate on the planetary wheel-holding frame 94, on the opposite face to that bearing the second planetary wheel 98, as seen in particular in FIG. 6D appended to the present patent application which shows the planetary wheel-holding frame 94 including counterbores 112 on the top and bottom faces, and top 108 and bottom 114 pivots. Finally, a solar pinion is formed by a first toothing 116 borne by the first cannon-pinion 78.

As mentioned above, the first planetary wheel 96 includes a cam follower finger 100 arranged to travel along the profile 104 of the first cam 88 against which it is held by the elasticity of the flexible hand 70. Similarly, the second planetary wheel 98 includes the cam follower finger 102 which is arranged to travel along the profile 106 of the second cam 92 while being returned elastically by the elasticity of the flexible hand 70.

Using the elasticity of the flexible hand 70 to ensure the elastic return of the cam follower fingers 100, 102 against the respective profiles 104, 106 of the cams 88, 92 is advantageous as this makes it possible to save on a return component which would be necessary to press the cam follower fingers 100, 102 against the profiles 104, 106 of the cams 88, 92.

The operation of the actuation mechanism 68 described above is as follows. This actuation mechanism 68 rests on the planetary wheel-holding frame 94 which is capable of rotating for example with a driving cannon-pinion 118 of the horological movement whereon it is fixedly fitted. This planetary wheel-holding frame 94 drives the whole actuation mechanism 68 in rotation along an angle θ1, except for the cams 88, 92 which are the only fixed elements. On this planetary wheel-holding frame 94, the two cannon-pinions 78, 80 on which the arms 74, 76 of the flexible hand 70 are fastened interact with the first and second planetary wheels 96, 98 which each bear a finger 100, 102 arranged to follow the respective profiles 104, 106 of the cams 88, 92.

The elastically prestressed flexible hand 70 constantly keeps the whole actuation mechanism 68 tensioned, whereby the cam follower fingers 100, 102 are always in contact with the respective profiles 104, 106 of the cams 88, 92.

The cannon-pinion 80 corresponding to the right arm 76 of the flexible hand 70 is driven directly meshed with the second planetary wheel 98. The cannon-pinion 78 corresponding to the left arm 74 of the flexible hand 70 is driven directly meshed with the first planetary wheel 96. The first and second cannon-pinions 78, 80 on which the arms 74, 76 of the flexible hand 70 are fastened are connected to one another via the planetary wheel-holding frame 94. When the planetary wheel-holding frame 94 rotates by an angle θ1, the first and second planetary wheels 96, 98 pivot on the respective bottom 114 and top 108 pivots thereof and rotate by an angle φ(θ1) under the effect of the interaction thereof with the cams 88, 92. The cannon-pinion 80 whereon the right arm 76 of the flexible hand 70 is fastened adds this angle φ(θ1) to the rotation θ1 of the planetary wheel-holding frame 94 in order to obtain the angle α(θ1). Conversely, the cannon-pinion 78 whereon the left arm 74 of the flexible hand 70 is fastened subtracts this angle φ(θ1) from the rotation θ1 in order to obtain the angle β(θ1).

The assembly of the additional plate comprising the whole actuation mechanism 68 is relatively easy. Particular attention is paid to the atypical hand-fitting for which a specific protocol is applied. As indicated above, the flexible hand 70 is continuously tensioned so that the elastic return makes up for the play in the geartrain of the actuation mechanism and holds the cam follower fingers 100, 102 against the cams 88, 92. When fitting the flexible hand 70, the cannons must be positioned beforehand such that the cam follower fingers 100, 102 are in contact against the cams 88, 92. The right arm 76 of the flexible hand 70 is then driven on the corresponding cannon-pinion 80 with a defined prestress angle, then the left arm 74 is driven on the cannon-pinion 78 with an identical prestress angle but of opposite direction to that of the right arm 76 with respect to a line D″ passing through the exit axis D′ and the point 72 of the flexible hand 70.

Composed of a few elements, the actuation mechanism 68 is simple and robust. The influence of the manufacturing tolerances is minimal. This actuation mechanism 68 can also comply with design modifications as a moderate change of the path of the point 72 of the flexible hand 70 can be obtained by only changing the geometry of the cams 88, 92.

Breguet's Reine de Naples “Coeur” watch is a harmonious creation where the innovation can be observed directly by the wearer. Besides its aesthetic side, watches equipped with the horological mechanism described above provide above all a response to the technical challenge of non-circular dials, while complying with conventional horological codes. The appeal perceived on observing the mysterious movement of the geartrains through a bottom of a watch is here transposed on the dial side, where the movement of the flexible hand and the shape and length variations thereof cause a genuine fascination.

Another embodiment of an actuation mechanism of a flexible hand is illustrated in FIGS. 7A and 7B appended to the present patent application. Designated as a whole by the general reference number 120, this actuation mechanism is arranged to drive for example a flexible hand 122 which is composed of a point 124 connected to two arms 126 and 128 each including a cannon 130, 132. The operating position of this flexible hand 122 is a stressed position wherein the first cannon 130 and the second cannon 132 are coaxial in relation to each other about an exit axis D′″.

The actuation mechanism 120 is completed by a planetary wheel-holding frame 134 which is equipped with a first pivot 136 whereon a planetary wheel 138 is fitted to rotate. As mentioned above, this planetary wheel 138 is equipped with a cam follower finger 140 arranged to travel along the profile 142 of a cam 144 against which it is held by the elasticity of the flexible hand 122. The cam 144 is the only fixed element of the actuation mechanism 120. The planetary wheel-holding frame 134 is also equipped with a fixed tube 146 whereon a first and a second driving cannon-pinion 148 and 150 are fitted free to rotate concentrically. The right arm 126 of the flexible hand 122 is driven on the second driving cannon-pinion 150 with a defined prestress angle, then the left arm 128 of the same flexible hand 122 is driven on the first driving cannon-pinion 148 with an identical prestress angle but of opposite direction to that of the right arm 126. Finally, the actuation mechanism 120 is completed by a first solar pinion 152 formed by a toothing borne by the first driving cannon-pinion 148, and by a second solar pinion 154 formed by a toothing borne by the second driving cannon-pinion 150. When the planetary wheel-holding frame 134 is driven in rotation by the horological movement, for example in the clockwise direction, it drives with it in the same direction the planetary wheel 138 which rotates on itself on travelling along the profile 142 of the cam 144 with the cam follower finger 140 thereof. The first driving cannon-pinion 148, meshing directly with this planetary wheel 138, therefore rotates on itself with respect to the planetary wheel-holding frame 134. As regards the second driving cannon-pinion 150, it rotates with respect to the planetary wheel-holding frame 134 at the same speed as the first driving cannon-pinion 148, but in the opposite direction, as the rotation of the planetary wheel 138 is transmitted thereto via an intermediate wheel 156 fitted free in rotation on a second pivot 158.

To switch the flexible hand 122 from a first to a second position, the actuation mechanism 120 applies an identical rotation of an angle φ but of opposite direction on each of the arms 126, 128 of the flexible hand 122. For this purpose, the actuation mechanism 120 is driven by the horological movement which applies a rotation by an angle θ1 to the entry of the planetary wheel-holding frame 134. This rotation by an angle θ1 is converted by the actuation mechanism 120 into a rotation by an angle α(θ1) of the right cannon 130 of the flexible hand 122, and into a rotation by an angle β(θ1) of the left cannon 132. The exit angles α(θ1) and β(θ1) of the actuation mechanism thus observe the following relations:

α(θ1)=θ1+φ(θ1) (1)

β(θ1)=θ1−φ(θ1) (2)

Assuming that the flexible hand 122 is symmetrical, the angular position θ2 of the point of the flexible hand 122 is defined as being the bisector of the two arms 126 and 128, i.e. the mean of the angles α(θ1) and β(θ1) according to the relation:

$$θ 2 = \frac{α ( θ 1 ) + β ( θ 1 )}{2} = θ 1 \qquad ( 3 )$$

The three actuation mechanisms described above enable the point of a flexible hand to describe a non-circular path on a complete revolution.

### SUMMARY OF THE INVENTION

The aim of the present invention is that of providing a mechanism driven by a horological movement and intended to actuate a flexible hand in which the shape and the length vary over two immediately successive revolutions so that the point of the flexible hand describes two mutually different paths.

For this purpose, the present invention relates to a flexible hand actuation mechanism to which a disk of a horological movement applies a first angular rotation θ1, the flexible hand comprising a first cannon and a second cannon connected to a point of the flexible hand via flexible arms, the first and second cannons being distant from each other when the flexible hand is in a non-stressed free state, an operating position wherein the flexible hand has a defined shape and length being a stressed position wherein the first cannon and the second cannon are coaxial about an exit axis, the first cannon being fitted with a first defined prestress angle, and the second cannon being fitted with a second defined prestress angle of opposite direction to that of the first cannon, the actuation mechanism being arranged to actuate the flexible hand such that the latter changes shape and length in the desired manner by varying the angular position of the second cannon with respect to the first cannon by pivoting about the exit axis, each of the flexible arms of the flexible hand performing the angular rotation θ1 applied by the disk of the horological movement to the actuation mechanism, the angular rotation θ1 applied by the disk of the horological movement being modulated by an additional angle

$$φ ( \frac{θ1}{2} )$$

by the actuation mechanism, this additional angle

$$φ ( \frac{θ1}{2} ) ,$$

applied with an opposite direction to the two flexible arms of the flexible hand, determining the change of shape and length of the flexible hand over two immediately successive revolutions such that the point of this flexible hand describes two mutually different paths, the shape and length variation ΔL(φ) being performed for a rotation by an angle 2×θ1 applied to an entry of this actuation mechanism by a geartrain of the horological movement.

According to special embodiments of the invention:
a cam follower finger feels a profile of a cam which determines the change of shape and length of the flexible hand, the flexible hand performing its two non-identical successive revolutions while the cam follower finger travels along the entire length of the cam profile;
the disk of the horological movement which applies the angular rotation θ1 to the actuation mechanism must perform two complete revolutions so that the cam follower finger travels along the entire can profile and the point of the flexible hand describes a path corresponding to two non-identical complete revolutions;
the cam follower finger is held against the cam profile thanks to a mechanical tension induced by the stressed fitting of the flexible hand;
the actuation mechanism comprises at least one rotary planetary wheel-holding frame which is driven by the disk of the horological movement and which bears the cam follower finger, this planetary wheel-holding frame performing a complete revolution while the disk of the horological movement performs two complete revolutions by applying the angular rotation θ1 thereto;
the cam is fixed;
the planetary wheel-holding frame bears a first solar wheel set and a second solar wheel set arranged coaxially with respect to each other, the first solar wheel set consisting of a first solar pinion and a first solar wheel, and the second solar wheel set consisting of a second solar pinion and a second solar wheel, the first pinion meshing with a planetary wheel borne by the planetary wheel-holding frame and which bears the cam follower finger, this planetary wheel meshing with an intermediate wheel which itself meshes with the second solar pinion, the actuation mechanism also comprising a first cannon-pinion and a second cannon-pinion arranged coaxially with respect to each other, the first cannon of the flexible hand being fastened to the first cannon-pinion, and the second cannon of the flexible hand being fastened to the second cannon-pinion;
the second solar wheel meshes with the first cannon-pinion which rotates by an angle

$$θ1 - φ ( \frac{θ1}{2} )$$

in a multiplicative ratio of 2, and the first solar wheel meshes with the second cannon-pinion which rotates by an angle

$$θ1 + φ ( \frac{θ1}{2} )$$

in a multiplicative ratio of 2;
the actuation mechanism comprises a first planetary wheel-holding frame engaged with a second planetary wheel-holding frame in a gear reduction ratio of 1/2, the first planetary wheel-holding frame bearing a first cannon-pinion and a second cannon-pinion that are concentric, each of the flexible arms of the flexible hand being driven on one of the cannon-pinions, the first and second cannon-pinion being kinematically linked to each other such that they rotate in opposite directions, the second planetary wheel-holding frame bearing a solar disk engaged with the second cannon-pinion, the second planetary wheel-holding frame also bearing a planetary wheel engaged with the solar disk and which is equipped with a cam follower finger arranged to travel along the cam profile, the cam follower finger feeling the profile of the fixed cam and the planetary wheel rotating and modulating at the same time the angular rotation θ1 applied by the disk of the horological movement to the solar disk by an angle

$$\frac{φ}{2} ( \frac{θ1}{2} ) ,$$

this solar disk in turn driving the second cannon-pinion which rotates by an angle

$$θ1 + φ ( \frac{θ1}{2} )$$

in a multiplicative ratio of 2, the second cannon-pinion driving the first cannon-pinion by an angle

$$θ1 - φ ( \frac{θ1}{2} ) ;$$

the cam is mobile;
the actuation mechanism comprises an intermediate reduction disk which, driven by a wheel of the horological movement, in turn drives a planetary wheel-holding frame so as to rotate it by an angle θ1, this planetary wheel-holding frame bearing a first cannon-pinion and a second cannon-pinion concentric with the first cannon-pinion, the planetary wheel-holding frame also bearing a first planetary wheel which meshes with the first cannon-pinion, on one hand, and with a second planetary wheel on the other hand, this second planetary wheel which meshes with the second cannon-pinion being equipped with a cam follower finger arranged to travel along the profile of a rotating cam against which it is held elastically, this rotating cam being driven by the horological movement in a reduction ratio 1/2, such that, when the planetary wheel-holding frame rotates by an angle θ1, the rotating cam rotates by an angle θ1/2, the second planetary wheel therefore rotating with the planetary wheel-holding frame by an angle θ1 about the exit axis while rotating on itself by an angle of rotation determined so as to modulate the rotation of the two flexible arms of the flexible hand by an angle

$$φ ( \frac{θ1}{2} )$$

so that the flexible hand changes length and shape in the desired manner.

So that the flexible hand is capable of performing two successive and non-identical complete revolutions by changing shape and length, each arm of the hand must rotate by the angle θ1 corresponding to the angle which would be applied by a cannon-pinion of the horological movement to a conventional minute hand, this angle θ1 being modulated by an angle φ by the actuation mechanism so that the flexible hand changes shape and length in the desired manner. This angle φ(θ1), applied with an opposite direction to the two arms of the flexible hand, determines the shape and length variation ΔL(φ) of the flexible hand.

### BRIEF DESCRIPTION OF THE FIGURES

Further features and advantages of the present invention will become more apparent from the following detailed description of a horological mechanism for actuating a flexible hand, this example being given purely by way of illustration and not merely limitation with reference to the appended drawing wherein:

FIG. 1A, cited above, illustrates the watch when it indicates 9:00, the flexible hand having a slender shape and its point pointing to the index “60” of the hour circle;

FIG. 1B, cited above, illustrates the watch when it indicates 9:23; the flexible hand being elastically deformed and forming a heart wherein the point points to the index “23” of the hour circle;

FIG. 2A, cited above, illustrates the geometry of the flexible hand during the manufacture thereof;

FIG. 2B, cited above, illustrates the principle of deformation of the flexible hand;

FIG. 3A, cited above, is a schematic diagram of the actuation of the flexible hand;

FIG. 3B, cited above, represents the angles of rotation of the cannons and of the flexible hand so that the point of this flexible hand travels along an angle θ1 which corresponds to the rotation applied by the horological movement to the entry of the actuation mechanism;

FIG. 3C, cited above, illustrates the evolution of the angles of rotation α and β of the flexible hand as a function of the angle of rotation θ1 which corresponds to the rotation applied by the horological movement to the entry of the actuation mechanism;

FIG. 4A, cited above, is an exploded perspective view of a first embodiment of an actuation mechanism of the flexible hand;

FIG. 4B is a partial sectional view of a horological movement driving the actuation mechanism;

FIG. 4C, cited above, is a perspective view of the actuation mechanism of FIG. 4A in the assembled state;

FIG. 5, cited above, illustrates a shape wheel whereon an angular guide-marking has been mounted so as to ensure the proper indexing thereof;

FIG. 6A, cited above, illustrates a second embodiment of the actuation mechanism of a flexible hand in the assembled state;

FIG. 6B, cited above, is a perspective view of the actuation mechanism in FIG. 6A in the disassembled state;

FIG. 6C, cited above, is a perspective view of a flexible hand arranged to be actuated by the actuation mechanism in FIGS. 6A and 6B;

FIG. 6D, cited above, shows the planetary wheel-holding frame including counterbores on the top and bottom faces, and top and bottom pivots;

FIG. 7A, cited above, is an exploded perspective view of a third embodiment of an actuation mechanism of a flexible hand according to the prior art, this actuation mechanism including a differential type device borne by a planetary wheel-holding frame, the two cannons of the flexible hand being coaxial about a first and a second cannon-pinion;

FIG. 7B, cited above, is a view in the assembled state of the actuation mechanism in FIG. 7A;

FIG. 8A is a schematic representation of a first embodiment of an actuation mechanism of a flexible hand according to the invention;

FIG. 8B is a perspective view of the actuation mechanism in FIG. 8A;

FIG. 8C is a top view of the actuation mechanism in FIG. 8A;

FIG. 9A is a schematic representation of a second embodiment of an actuation mechanism of a flexible hand according to the invention;

FIG. 9B is a perspective view of the actuation mechanism in FIG. 9A;

FIG. 9C is a top view of the actuation mechanism in FIG. 9A;

FIG. 10A is a schematic representation of a third embodiment of an actuation mechanism of a flexible hand according to the invention;

FIG. 10B is a perspective view of the actuation mechanism in FIG. 9A;

FIG. 10C is a top view of the actuation mechanism in FIG. 9A;

FIGS. 11A and 11B illustrate two different directly successive paths of the flexible hand when it is driven by one of the actuation mechanisms according to the invention.

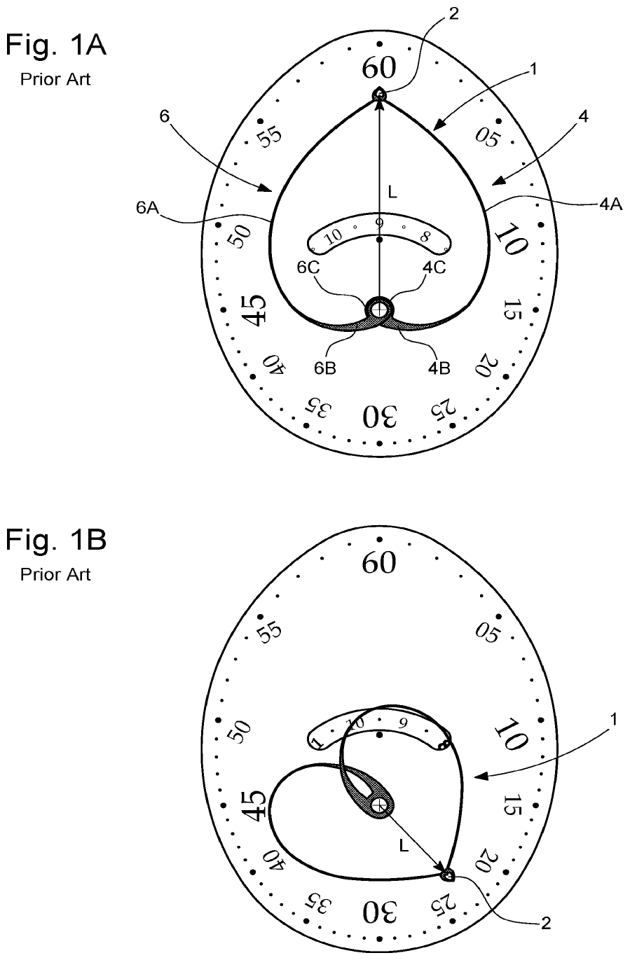

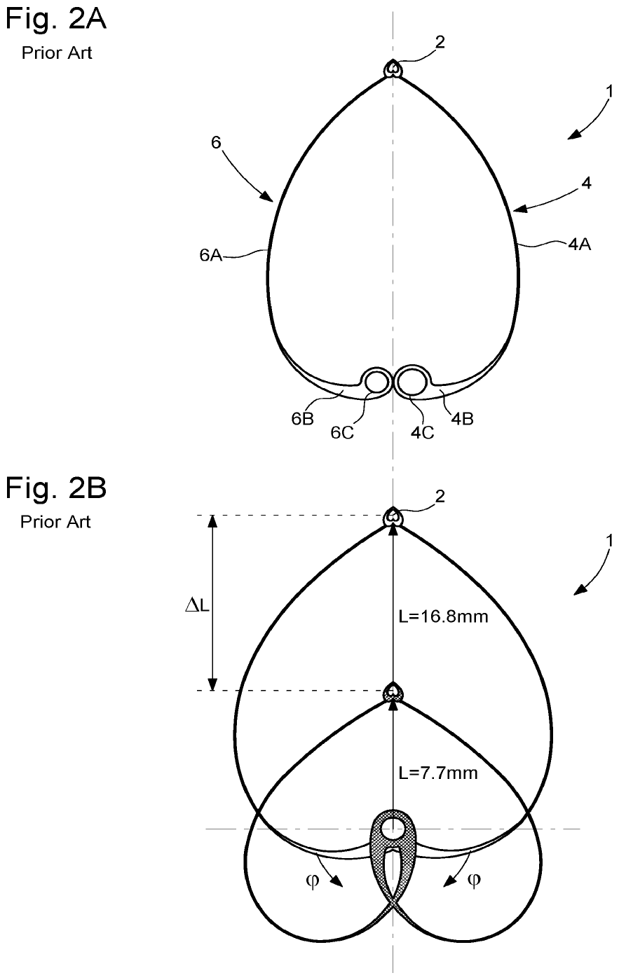

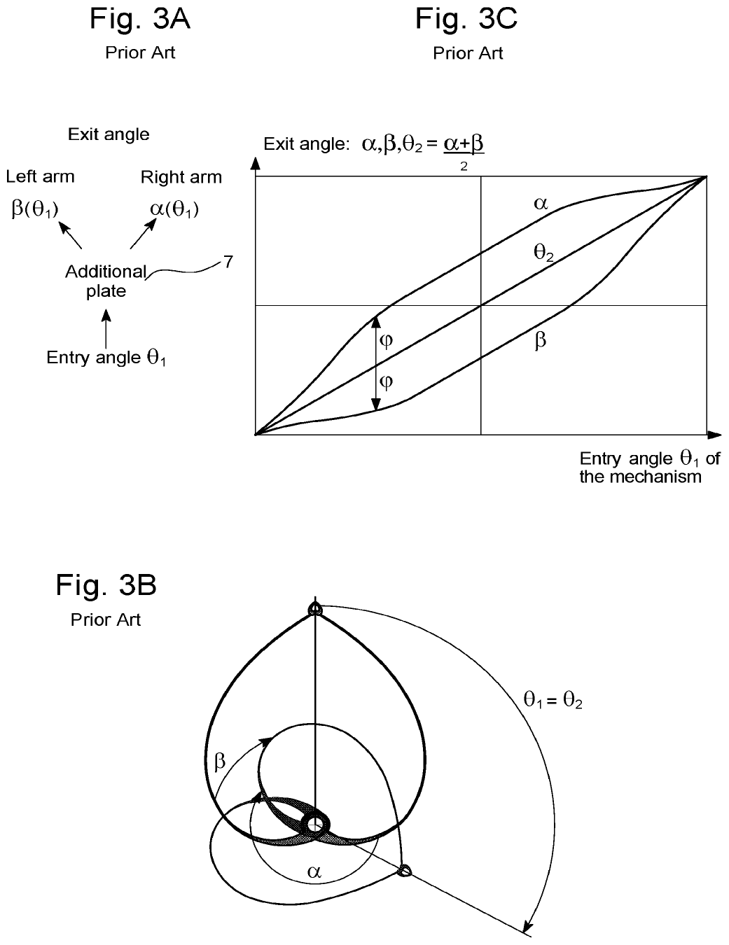

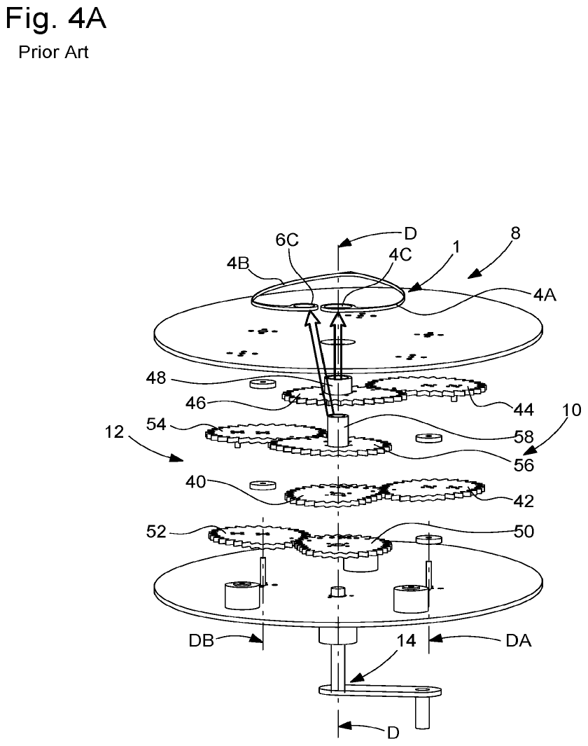

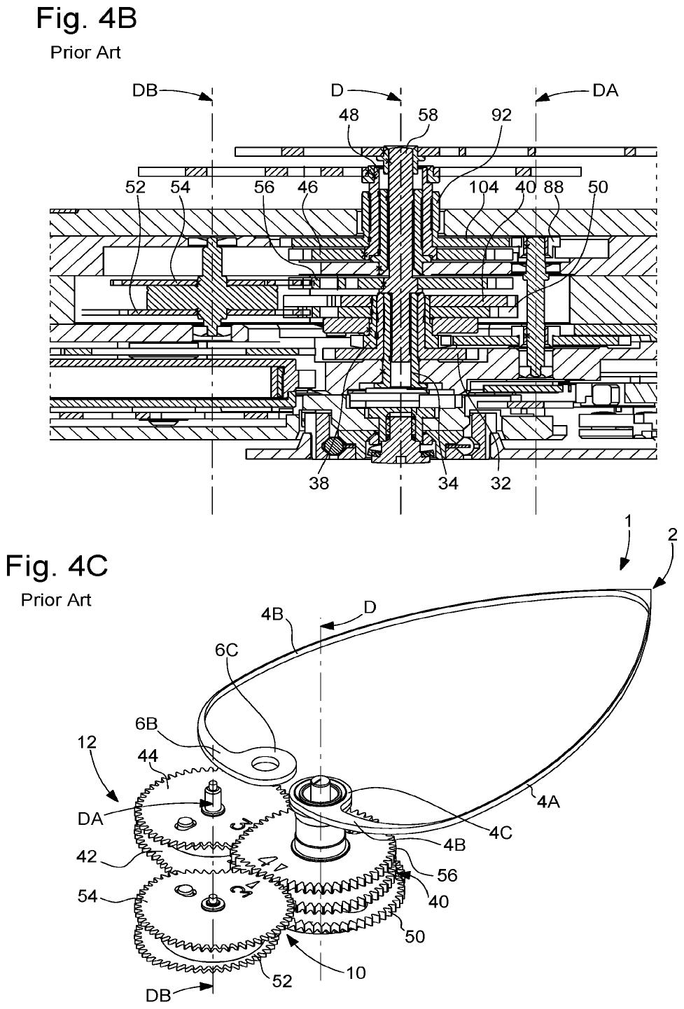

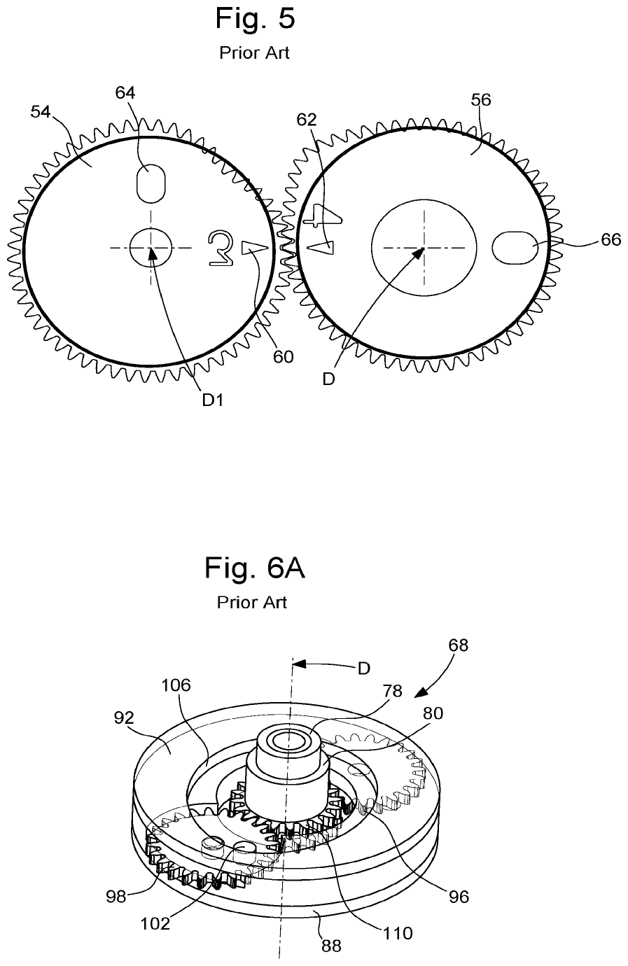

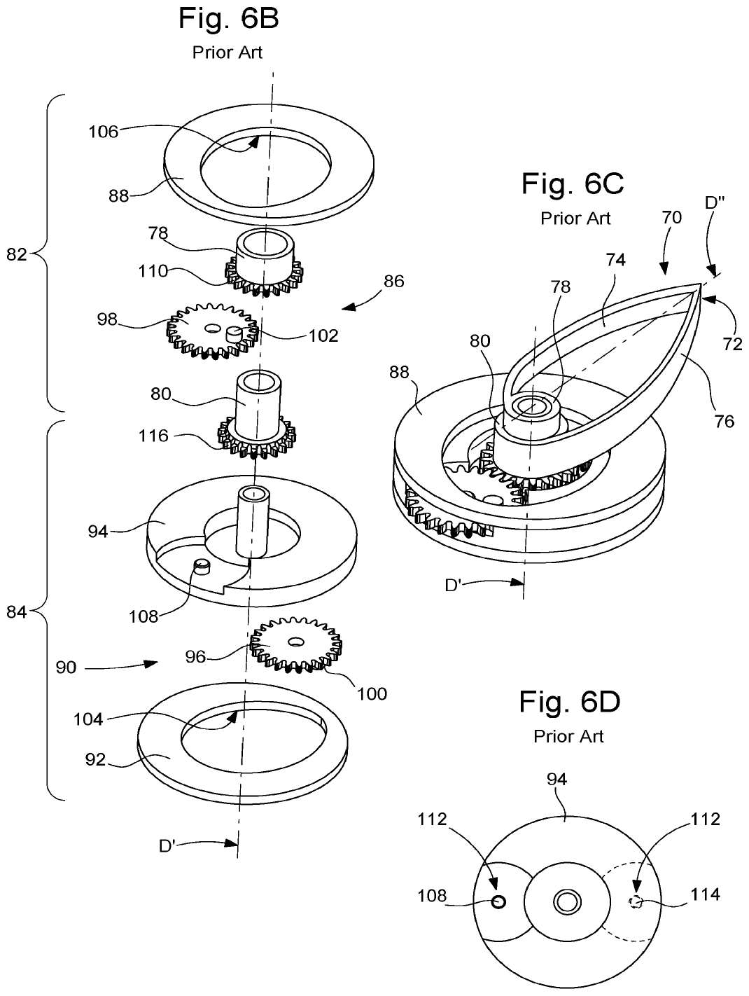

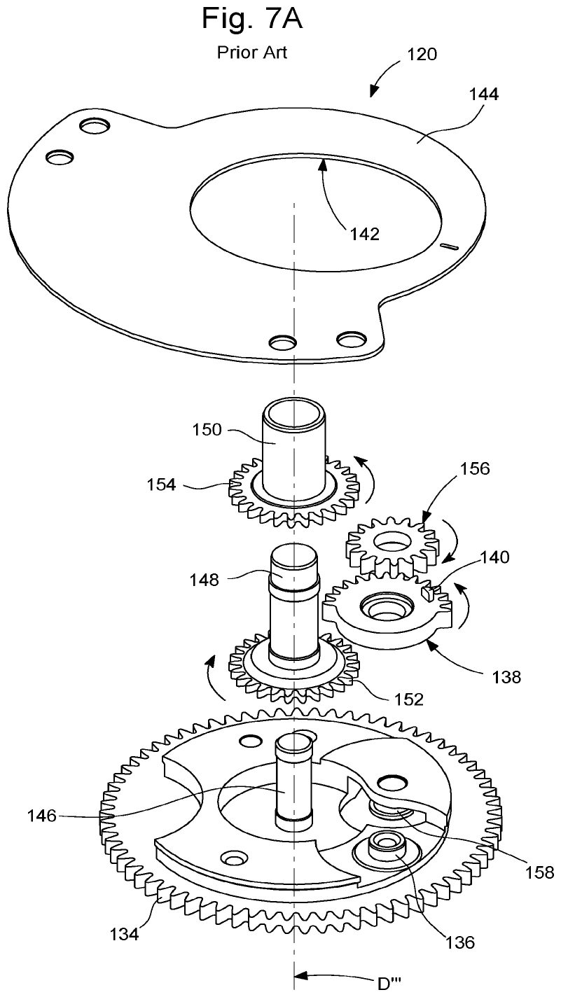

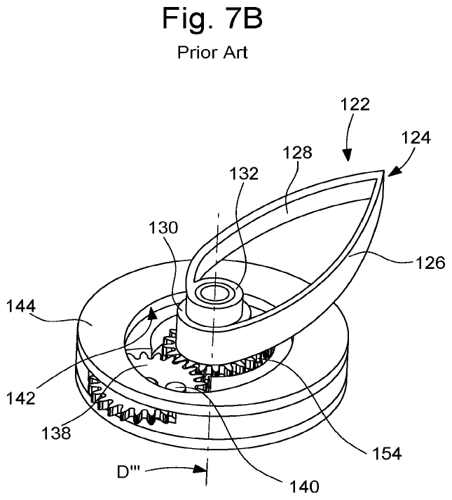

### DETAILED DESCRIPTION OF THE INVENTION

The present invention stems from the general inventive idea which consists of providing a mechanism driven by a horological movement and intended to actuate a flexible hand in which the shape and the length vary over two immediately successive revolutions so that the point of the hand describes two mutually different paths.

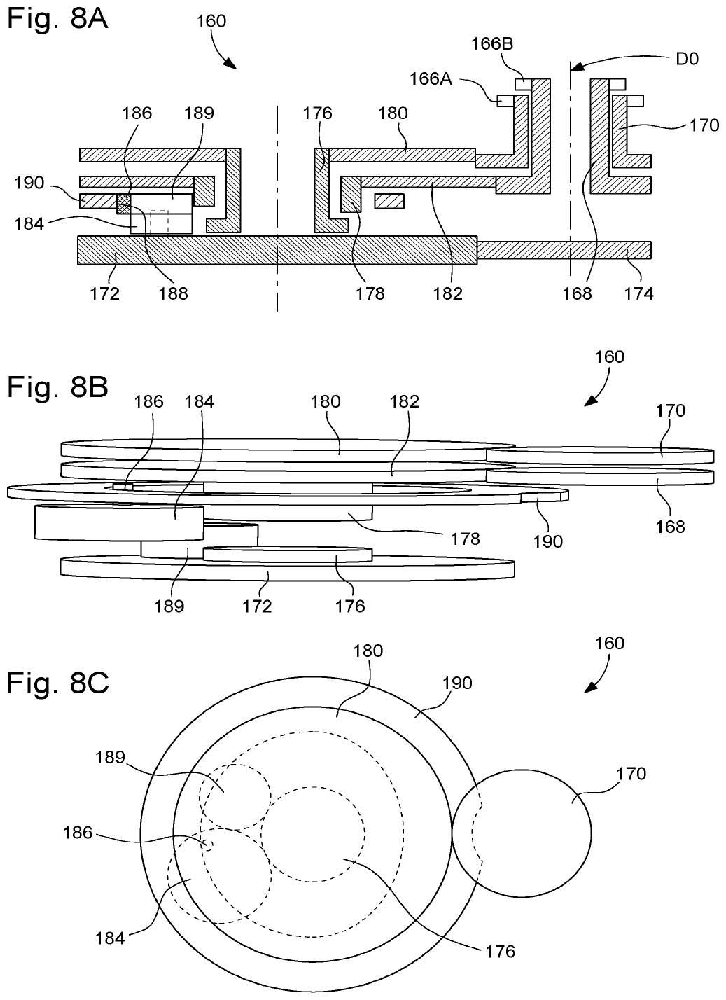

A first embodiment of an actuation mechanism according to the invention is represented in FIGS. 8A-8C. Designated as a whole by the general reference number 160, this actuation mechanism is arranged to drive a flexible hand 162 of the type described above which consists of a point 164 connected to a first and a second cannon 166A, 166B via respective flexible arms 166. So that the flexible hand 162 is capable of performing two successive and non-identical complete revolutions by changing shape and length, each flexible arm 166 of the flexible hand 162 must rotate by the angle θ1 corresponding to the angle which would be applied by a cannon-pinion of the horological movement to a conventional minute hand, this angle θ1 being modulated by an angle φ by the actuation mechanism 160 so that the flexible hand 162 changes shape and length in the desired manner. This angle φ, applied with an opposite direction to the two flexible arms 166 of the flexible hand 162, determines the shape and length variation ΔL(φ) of the flexible hand. For this purpose, the first cannon 166A corresponding to the right flexible arm 166 of the flexible hand 162 is fastened to a second cannon-pinion 170, and the second cannon 166B corresponding to the left flexible arm 166 of the flexible hand 162 is fastened to a first cannon-pinion 168, the two cannon-pinions 168, 170 being disposed concentrically about an exit axis D0.

The actuation mechanism 160 comprises a planetary wheel-holding frame 172 at an entry of which a wheel 174 of a horological movement applies a rotation by an angle θ1 such that the planetary wheel-holding frame 172 rotates by an angle θ1/2 when the wheel 174 rotates by the angle θ1. The planetary wheel-holding frame 172 bears a first solar pinion 176 and a second solar pinion 178 disposed coaxially. The first solar pinion 176 bears a first solar wheel 180 and the second solar pinion 178 bears a second solar wheel 182. The first solar pinion 176 meshes with a planetary wheel 184 which bears a cam follower finger 186 arranged to travel along the profile 188 of a fixed cam 190 against which it is held by the elasticity of the flexible hand of the type described in detail above. The planetary wheel 184 meshes with an intermediate wheel 189 which in turn meshes with the second solar pinion 178. It is understood that the wheel 174 must perform two complete revolutions so that the cam follower finger 186 travels along the entire profile 188 of the fixed cam 190 and the point 164 of the flexible hand 162 describes a path corresponding to two non-identical complete revolutions. The second solar wheel 182 meshes with the first cannon-pinion 168 which rotates by an angle

$$θ1 + φ ( \frac{θ1}{2} )$$

in a multiplicative ratio of 2, and the first solar wheel 180 meshes with the second cannon-pinion 170 which rotates by an angle

$$θ1 - φ ( \frac{θ1}{2} )$$

in a multiplicative ratio of 2.

A right flexible arm 166 of the flexible hand 162 is driven on the second cannon-pinion 170 and a left flexible arm 166 of the flexible hand 162 is driven on the first cannon-pinion 168. The right and left flexible arms 166 of the flexible hand 162 thus describe the following angles:

$$α ( θ 1 ) = θ1 + φ ( \frac{θ 1}{2} )$$

$$β ( θ1 ) = θ1 - φ ( \frac{θ 1}{2} )$$

Assuming that the flexible hand 162 is symmetrical, the angular position θ2 of the point 164 of the flexible hand 162 is defined as being the bisector of the two flexible arms 166, i.e. the mean of the angles α(θ1) and β(θ1) according to the relation:

$$θ 2 = \frac{α ( θ 1 ) + β ( θ 1 )}{2} = θ 1 \qquad ( 3 )$$

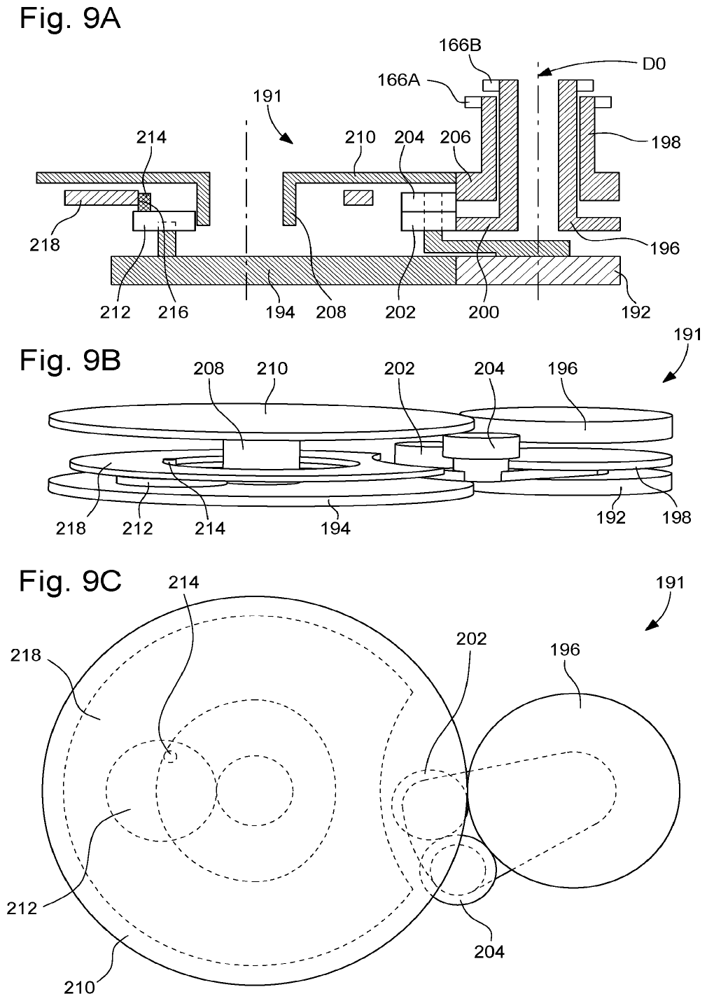

A second embodiment of an actuation mechanism of a flexible hand 162 according to the invention is illustrated schematically in FIGS. 9A-9C. Designated as a whole by the general reference number 191, this actuation mechanism comprises a first planetary wheel-holding frame 192 engaged with a second planetary wheel-holding frame 194 in a gear reduction ratio of 1/2. So that the flexible hand 162 is capable of performing two successive and non-identical complete revolutions by changing shape and length, each flexible arm 166 of the flexible hand 162 must rotate by the angle θ1 corresponding to the angle which would be applied by a cannon-pinion of the horological movement to a conventional minute hand, this angle 81 being modulated by an angle φ by the actuation mechanism 191 so that the flexible hand 162 changes shape and length in the desired manner. This angle φ(θ1), applied with an opposite direction to the two flexible arms 166 of the flexible hand 162 about the exit axis D0, determines the shape and length variation ΔL(φ) of the flexible hand 162.

In this aim, the first planetary wheel-holding frame 192 bears a first cannon-pinion 196 and a second cannon-pinion 198 that are concentric. A right flexible arm 166 of the flexible hand 162 is driven on the second cannon-pinion 198 and a left flexible arm 166 of the flexible hand 162 is driven on the first cannon-pinion 196. A first solar pinion 200 formed by a first toothing borne by the first cannon-pinion 196 meshes with a first planetary wheel 202 fitted free to rotate on the first planetary wheel-holding frame 192. This first planetary wheel 202 meshes with a second planetary wheel 204 also fitted free to rotate on the first planetary wheel-holding frame 192 and engaged with a second solar pinion 206 formed by a second toothing borne by the second cannon-pinion 198. The function of these first and second planetary wheels 202 and 204 is that of rotating the first and second cannon-pinions 196, 198 in the opposite direction of each other with respect to the first planetary wheel-holding frame 192 about the exit axis D0.

The second planetary wheel-holding frame 194 bears a solar disk formed from a solar pinion 208 and a solar wheel 210 which is engaged with the second solar pinion 206 of the second cannon-pinion 198. The second planetary wheel-holding frame 194 also bears a third planetary wheel 212 engaged with the solar pinion 208 and which is equipped with a cam follower finger 214 arranged to travel along the profile 216 of a fixed cam 218 against which it is held by the elasticity of the flexible hand in the manner described in detail above. When the first planetary wheel-holding frame 192 rotates on itself by an angle θ1, the second planetary wheel-holding frame 194 therefore also rotates on itself by an angle θ1/2. This planetary wheel-holding frame 194 bears the third planetary wheel 212 which feels the profile 216 of the fixed cam 218 by rotating by an angle

$$\frac{φ}{2} ( \frac{θ 1}{2} ) .$$

While it follows the profile 216 of the fixed cam 218, the third planetary wheel 212 rotates and simultaneously modulates the angular rotation θ1 applied by the horological movement to the solar wheel 210 by an angle

$$\frac{φ}{2} ( \frac{θ 1}{2} )$$

this solar wheel 210 in turn driving the second cannon-pinion 198 which rotates by an angle

$$θ 1 + φ ( \frac{θ 1}{2} )$$

in a multiplicative ratio of 2. It will be understood that the first and second cannon-pinions 196, 198 rotate with respect to the first planetary wheel-holding frame 192 in the opposite direction with respect to each other.

Finally, the second cannon-pinion 198 drives the first cannon-pinion 196 by an angle

$$θ 1 - φ ( \frac{θ 1}{2} ) .$$

The right and left flexible arms 166 of the flexible hand 162 thus describe the following angles:

$$α ( θ 1 ) = θ1 + φ ( \frac{θ 1}{2} )$$

$$β ( θ1 ) = θ1 - φ ( \frac{θ 1}{2} )$$

Assuming that the flexible hand 162 is symmetrical, the angular position θ2 of the point 164 of the flexible hand 162 is defined as being the bisector of the two flexible arms 166, i.e. the mean of the angles α(θ1) and β(θ1) according to the relation:

$$θ 2 = \frac{α ( θ 1 ) + β ( θ 1 )}{2} = θ 1$$

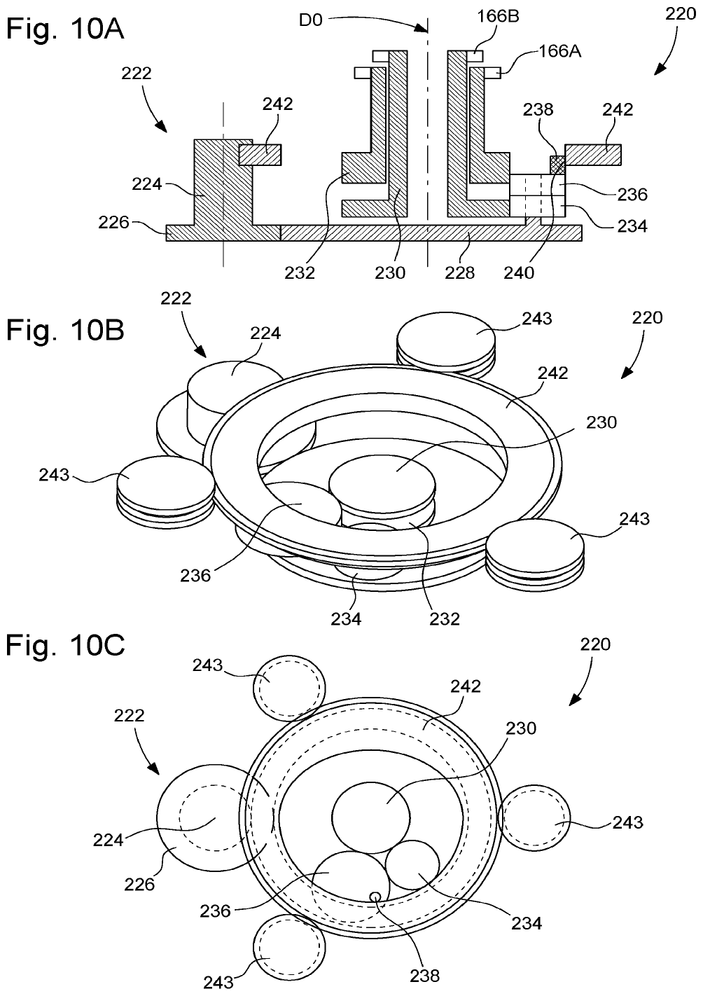

A third embodiment of an actuation mechanism of a flexible hand according to the invention is illustrated schematically in FIGS. 10A-10C. Designated as a whole by the general reference number 220, this actuation mechanism comprises an intermediate reduction wheel set 222 which consists of an intermediate reduction wheel 226 and an intermediate reduction pinion 224. A planetary wheel-holding frame 228, driven by a wheel of the horological movement by an angle θ1, in turn drives the intermediate reduction wheel 226. This planetary wheel-holding frame 228 bears a first cannon-pinion 230 and a second cannon-pinion 232 concentric with the first cannon-pinion 230. The planetary wheel-holding frame 228 also bears a first planetary wheel 234 fitted free to rotate on a pivot and which meshes with the first cannon-pinion 230, on one hand, and with a second planetary wheel 236 fitted free to rotate on another pivot, on the other. This second planetary wheel 236 which meshes with the second cannon-pinion 232 is equipped with a cam follower finger 238 arranged to travel along the profile 240 of a rotating cam 242 against which it is held by the elasticity of the flexible hand 162. This rotating cam 242 is guided by runners 243 and is engaged with the intermediate reduction wheel 222, such that, when the planetary wheel-holding frame 228 rotates by an angle θ1, the rotating cam 242 rotates by an angle θ1/2. The first cannon-pinion 230 therefore rotates by an angle θ1 modulated by an angle

$$φ ( \frac{θ 1}{2} )$$

by the actuation mechanism 220 so that the flexible hand changes shape and length in the desired manner. This angle

$$φ ( \frac{θ 1}{2} ) ,$$

applied with an opposite direction to the two flexible arms 166 of the flexible hand 162, determines the shape and length variation ΔL(φ) of the flexible hand 162. The right and left flexible arms 166 of the flexible hand 162 thus describe the following angles:

$$α ( θ1 ) = θ1 + φ ( \frac{θ 1}{2} )$$

$$β ( θ1 ) = θ1 - φ ( \frac{θ 1}{2} )$$

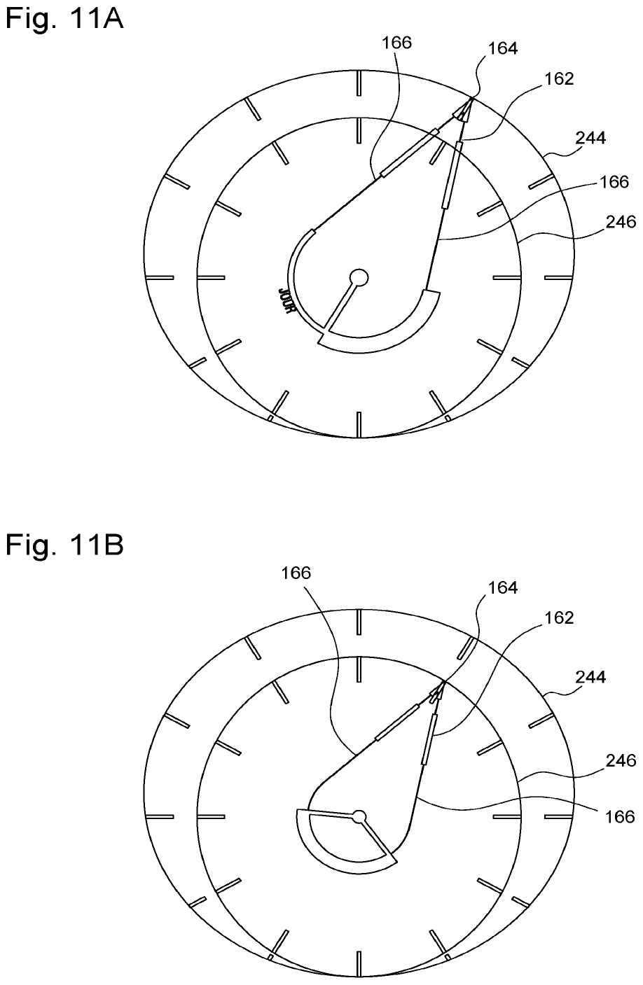

Finally, FIGS. 11A and 11B illustrate two different positions of the flexible hand 162 capable of being driven by one of the actuation mechanisms according to the invention described hereinabove, and of which the shape and length variation ΔL(φ) is performed for a rotation by an angle 2×θ1 applied to an entry of this actuation mechanism by a geartrain of the horological movement. In FIGS. 11A and 11B, it is seen that the point 164 of the flexible hand 162 is capable of describing two substantially circular paths 244 and 246 which differ from one another by the value of the radius thereof and which are not concentric.

It goes without saying that the invention is not limited to the embodiment that has just been described, and that miscellaneous modifications and simple variants may be envisaged by the person skilled in the art without departing from the scope of the invention as defined by the appended claims. It will be understood in particular that the paths described by the point of a flexible hand driven by the actuation mechanism according to the invention when this flexible hand performs two successive complete revolutions are different from each other and can, obviously, deviate from a circular shape.

### LIST OF REFERENCES

1. Flexible hand
2. Point
4. Arm
4A. Flexible part
4B. Rigid part
4C. Cannon
6. Arm
6A. Flexible part
6B. Rigid part
6C. Cannon
7. Additional plate
8. Actuation mechanism
10. First shape geartrain
12. Second shape geartrain
14. Movement gear
16. Horological movement
DA. First axis
D. Main pivoting axis
DB. Second axis
32. Fixed tube
34. Entry disk
38. Driving cannon-pinion
40. First shape wheel
42. Second shape wheel
44. Third shape wheel
46. Fourth shape wheel
48. Cannon-pinion
50. Fifth shape wheel
52. Sixth shape wheel
54. Seventh shape wheel
56. Eighth shape wheel
58. Cannon-pinion
60. Guide-mark
62. Guide-mark
64. Oblong hole
66. Oblong hole
L Length
68. Actuation mechanism
70. Flexible hand
72. Point
74. Arm
76. Arm
78. First cannon-pinion
80. Second cannon-pinion
D′. Exit axis
82. First drive means
84. Second drive means
86. First differential
88. First cam
90. Second differential
92. Second cam
94. Planetary wheel-holding frame
96. First planetary wheel
98. Second planetary wheel
100. Cam follower finger
102. Cam follower finger
104. Profile
106. Profile
108. Top pivot
110. Second toothing
112. Counterbores
114. Bottom pivot
116. First toothing
118. Driving cannon-pinion
D″. Right
120. Actuation mechanism
122. Flexible hand
124. Point
126. First arm
128. Second arm
130. First cannon
132. Second cannon
D′″. Exit axis
134. Planetary wheel-holding frame
136. First pivot
138. Planetary wheel
140. Cam follower finger
142. Profile
144. Cam
146. Fixed tube
148. First driving cannon-pinion
150. Second driving cannon-pinion
152. First solar pinion
154. Second solar pinion
156. Wheel of intermediate wheel
158. Second pivot
160. Actuation mechanism
162. Flexible hand
164. Point
166. Flexible arms
166A. Cannon
166B. Cannon
168. First cannon-pinion
170. Second cannon-pinion
172. Planetary wheel-holding frame
174. Wheel
176. First solar pinion
178. Second solar pinion
180. First solar wheel
182. Second solar wheel
184. Planetary wheel
186. Cam follower finger
188. Profile
189. Intermediate wheel
190. Fixed cam
191. Actuation mechanism
192. First planetary wheel-holding frame
194. Second planetary wheel-holding frame
196. First cannon-pinion
198. Second cannon-pinion
200. First solar pinion
202. First planetary wheel
204. Second planetary wheel
206. Second solar pinion
208. Solar pinion
210. Solar wheel
212. Third planetary wheel
214. Cam follower finger
216. Profile
218. Fixed cam
220. Actuation mechanism
222. Intermediate reduction disk
224. Intermediate reduction pinion
226. Intermediate reduction wheel
228. Planetary wheel-holding frame
230. First cannon-pinion
232. Second cannon-pinion
234. First planetary wheel
236. Second planetary wheel
238. Cam follower finger
240. Profile
242. Rotating cam
243. Runners
244. Circular path
246. Circular path

1. A flexible hand actuation mechanism to which a disk of a horological movement applies a first angular rotation θ1, the flexible hand comprising a first cannon and a second cannon connected to a point of the flexible hand via flexible arms, the first and second cannons being distant from each other when the flexible hand is in a non-stressed free state, an operating position wherein the flexible hand has a defined shape and length being a stressed position wherein the first cannon and the second cannon are coaxial about an exit axis, the first cannon being fitted with a first defined prestress angle, and the second cannon being fitted with a second defined prestress angle of opposite direction to that of the first cannon, the actuation mechanism being arranged to actuate the flexible hand such that the latter changes shape and length in the desired manner by varying the angular position of the second cannon with respect to the first cannon by pivoting about the exit axis, each of the flexible arms of the flexible hand performing the angular rotation θ1 applied by the disk of the horological movement to the actuation mechanism, the angular rotation θ1 applied by the disk of the horological movement being modulated by an additional angle
$$φ ( \frac{θ 1}{2} )$$
by the actuation mechanism, said additional angle
$$φ ( \frac{θ 1}{2} ) ,$$
applied with an opposite direction to the two flexible arms of the flexible hand, determining the change of shape and length of the flexible hand over two immediately successive revolutions such that the point of said flexible hand describes two mutually different paths, the shape and length variation ΔL(φ) being performed for a rotation by an angle 2×θ1 applied to an entry of said actuation mechanism by a geartrain of the horological movement.

2. The actuation mechanism according to claim 1, further comprising a cam follower finger which feels a profile of a cam which determines the change of shape and length of the flexible hand, the flexible hand performing its two non-identical successive revolutions while the cam follower finger travels along the profile of the cam along the entire profile thereof.

3. The actuation mechanism according to claim 2, wherein the disk of the horological movement which applies the angular rotation θ1 to the actuation mechanism must perform two complete revolutions so that the cam follower finger travels along the entire profile of the cam and the point of the flexible hand describes a path corresponding to two non-identical complete revolutions.

4. The actuation mechanism according to claim 2, wherein the cam follower finger is held against the profile of the cam thanks to a mechanical tension induced by the stressed fitting of the flexible hand.

5. The actuation mechanism according to claim 3, wherein the cam follower finger is held against the profile of the cam thanks to a mechanical tension induced by the stressed fitting of the flexible hand.

6. The actuation mechanism according to claim 2, wherein the actuation mechanism comprises at least one rotary planetary wheel-holding frame which is driven by the disk of the horological movement and which bears the cam follower finger, said planetary wheel-holding frame performing an angular rotation θ1/2 while the disk of the horological movement applies the angular rotation θ1 thereto.

7. The actuation mechanism according to claim 3, wherein the actuation mechanism comprises at least one rotary planetary wheel-holding frame which is driven by the disk of the horological movement and which bears the cam follower finger, said planetary wheel-holding frame performing an angular rotation θ1/2 while the disk of the horological movement applies the angular rotation θ1 thereto.

8. The actuation mechanism according to claim 4, wherein the actuation mechanism comprises at least one rotary planetary wheel-holding frame which is driven by the disk of the horological movement and which bears the cam follower finger, said planetary wheel-holding frame performing an angular rotation θ1/2 while the disk of the horological movement applies the angular rotation θ1 thereto.

9. The actuation mechanism according to claim 5, wherein the actuation mechanism comprises at least one rotary planetary wheel-holding frame which is driven by the disk of the horological movement and which bears the cam follower finger, said planetary wheel-holding frame performing an angular rotation θ1/2 while the disk of the horological movement applies the angular rotation θ1 thereto.

10. The actuation mechanism according to claim 6, wherein the cam is fixed.

11. The actuation mechanism according to claim 7, wherein the cam is fixed.

12. The actuation mechanism according to claim 8, wherein the cam is fixed.

13. The actuation mechanism according to claim 9, wherein the cam is fixed.

14. The actuation mechanism according to claim 10, wherein the planetary wheel-holding frame bears a first solar wheel set and a second solar wheel set arranged coaxially with respect to each other, the first solar wheel set consisting of a first solar pinion and a first solar wheel, and the second solar wheel set consisting of a second solar pinion and a second solar wheel, the first solar pinion meshing with a planetary wheel borne by the planetary wheel-holding frame and which bears the cam follower finger, said planetary wheel meshing with an intermediate wheel which itself meshes with the second solar pinion, the actuation mechanism also comprising a first cannon-pinion and a second cannon-pinion arranged coaxially with respect to each other, the first cannon of the flexible hand being fastened to the first cannon-pinion, and the second cannon of the flexible hand being fastened to the second cannon-pinion.

15. The actuation mechanism according to claim 14, wherein the second solar wheel meshes with the first cannon-pinion which rotates by an angle
$$θ 1 - φ ( \frac{θ 1}{2} )$$
in a multiplicative ratio of 2, and the first solar wheel meshes with the second cannon-pinion which rotates by an angle
$$θ 1 + φ ( \frac{θ 1}{2} )$$
in a multiplicative ratio of 2.

16. The actuation mechanism according to claim 10, wherein the actuation mechanism comprises a first planetary wheel-holding frame engaged with a second planetary wheel-holding frame in a gear reduction ratio of 1/2, the first planetary wheel-holding frame bearing a first cannon-pinion and a second cannon-pinion that are concentric, each of the flexible arms of the flexible hand being driven on one of the cannon-pinions, the first and second cannon-pinion being kinematically linked to each other such that they rotate with respect to the first planetary wheel-holding frame in opposite directions with respect to each other, the second planetary wheel-holding frame bearing a solar disk engaged with the second cannon-pinion, the second planetary wheel-holding frame also bearing a planetary wheel engaged with the solar disk and which is equipped with a cam follower finger arranged to travel along the profile of the cam, the cam follower finger feeling the profile of the fixed cam and the planetary wheel rotating and modulating at the same time the angular rotation θ1 applied by the disk of the horological movement to the solar disk by an angle
$$\frac{φ}{2} ( \frac{θ 1}{2} ) ,$$
said solar disk in turn driving the second cannon-pinion which rotates by an angle
$$θ 1 + φ ( \frac{θ 1}{2} )$$
in a multiplicative ratio of 2, the second cannon-pinion driving the first cannon-pinion by an angle
$$θ 1 - φ ( \frac{θ 1}{2} ) .$$

17. The actuation mechanism according to claim 6, wherein the cam is mobile.

18. The actuation mechanism according to claim 17, wherein the actuation mechanism comprises a planetary wheel-holding frame which, driven by a wheel of the horological movement by an angle θ1, in turn drives an intermediate reduction disk, said planetary wheel-holding frame bearing a first cannon-pinion and a second cannon-pinion concentric with the first cannon-pinion, the planetary wheel-holding frame also bearing a first planetary wheel which meshes with the first cannon-pinion, on one hand, and with a second planetary wheel, on the other, said second planetary wheel which engages with the second cannon-pinion being equipped with a cam follower finger arranged to travel along the profile of a rotating cam against which it is held elastically, said rotating cam being engaged with the intermediate reduction disk, such that, when the planetary wheel-holding frame rotates by an angle θ1, the rotating cam rotates by an angle θ1/2, the second planetary wheel therefore rotating with the planetary wheel-holding frame by an angle θ1 about the exit axis while rotating on itself by an angle of rotation determined so as to modulate the rotation of the two flexible arms of the flexible hand by an angle
$$φ ( \frac{θ 1}{2} )$$
so that the flexible hand changes length and shape in the desired manner
